(19) United States
(12) Patent Application Publication
(10) Pub. No.: US 2011/0302451 A1
(43) Pub. Date: Dec. 8, 2011

(54) FINANCIAL INTEGRATION TEST PROCESS

(75) Inventors: Terri Smith, Richardson, TX (US); Michelle L. Johnson, Dallas, TX (US)

(73) Assignee: METROPCS WIRELESS, INC., RICHARDSON, TX (US)

(21) Appl. No.: 12/796,019

(22) Filed: Jun. 8, 2010

(51) Int. Cl. G06F 11/07; G06F 1/12

(52) U.S. Cl. 714/32; 714/E11.024; 709/248; 714/E11.023

(57) ABSTRACT

A method for testing financial operations of network applications within a computer network generates a test matrix to store test data relating to testing of financial operations related to the network applications within the computer network. A unique testing scenario is developed for testing the financial operations across a plurality of network applications and stored within the test matrix. An expected financial result achieved in accordance with execution of the unique testing scenario is calculated and stored within the test matrix. The unique testing scenario is executed using the network applications within the computer network to achieve an actual financial test result which is stored within the test matrix. The expected financial result is compared with the actual financial result to detect issues within the network applications relating to financial operations.

### TECHNICAL FIELD

The present invention relates to system operation testing, and more particularly to testing the operation of a system specifically with respect to the financial operations of the system.

### BACKGROUND

Within the modern corporate or business environment, various types of systems operate together in order to provide the operational capabilities to the corporation or business. Many businesses or corporations operate using large computer networks that use combined hardware and software in order to provide the various operations and functionalities of the associated business. During the life cycle of the businesses, software for operating the corporate network is often updated to newer versions in order to provide improved business operating capabilities.

Responsive to each of these system software upgrades, there is a need to test the system in order to confirm that the system is operating in a satisfactory manner and as expected, after the system upgrade. Present implementations normally involve testing the overall system functional operation in order to confirm that the general system operation is being maintained according to a desired set of parameters. However, the overall system functional operation may include any number of functionalities involving things such as administrative, financial, informational, operational, etc., operations. Typical testing methodologies do not focus on detailed aspects of a system, such as customer level financial system affects caused by a system upgrade. For example, if a particular cellular network service provider upgraded various parts of the system, it is desirable to confirm that the software or computer upgrade in no way affects the revenue generation/billing requirements of the cellular network service provider in an adverse manner.

There presently exists no satisfactory methodology for insuring 100 percent accuracy of financial results that may be affected during a system application change, upgrade, enhancement or integration. This type of system inaccuracy can adversely affect financial statement accuracy and customer invoicing during times of system change. Some manner for providing a testing process that controls risk associated with system change as it relates to the financial aspect of the system would be of great benefit to a corporation or business in order to assure that upgrading their system is not going to adversely affect their related financial reporting.

### SUMMARY

The present invention, as disclosed and described herein, in one aspect thereof comprises a method for testing financial operations of network applications within a computer network. A test matrix is generated to store test data relating to testing of financial operations related to the network applications within the computer network. A unique customer level testing scenario is developed for testing the financial operations across a plurality of network applications and stored within the test matrix. An expected financial result achieved in accordance with execution of the unique testing scenario is calculated and stored within the test matrix. The unique testing scenario is executed using the network applications within the computer network to achieve an actual financial test result which is stored within the test matrix. The expected financial result is compared with the actual financial result to detect issues within the network applications relating to financial operations.

### BRIEF DESCRIPTION OF THE DRAWINGS

For a more complete understanding, reference is now made to the following description taken in conjunction with the accompanying Drawings in which:

FIG. 1A illustrates the various structural components that may be interrelated within an overall IT system configuration relating to financial accuracy;

FIG. 1B illustrates the data flow from, for example a billing system to various system components to enable the generation of billing system reports;

FIG. 2 illustrates a general manner for providing end-to-end financial testing responsive to a system upgrade;

FIG. 3 is a flow diagram describing the overall process for providing the end-to-end financial testing illustrated with respect to FIG. 2;

FIG. 4 illustrates a test matrix used for providing an end-to-end financial test;

FIG. 5 is a detailed flow diagram describing the process for providing an end-to-end financial test;

FIG. 6 illustrates a first example of the financial test process correcting a system problem;

FIG. 7 illustrates a second example of the financial integration process correcting a system problem;

FIG. 8 illustrates a further example of a financial problem being corrected by the financial integration test process; and

FIG. 9 illustrates a final example of the correction of a system problem using the financial test process.

### DETAILED DESCRIPTION

Referring now to the drawings, wherein like reference numbers are used herein to designate like elements throughout, the various views and embodiments of financial integration test process are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Referring now to the drawings, and more particularly to FIG. 1A, there is illustrated an example of an overall IT system configuration 102 for a large corporate or business network. The IT system configuration 102 can include various financial components 104 that are associated with the financial operation of the business or corporation. This can include things such as billing software, invoicing software, collections software, software-tracking systems associated with the users such as monthly fees and additional charges for use-based services. Administrative components 106 can be used for administering IT system operations, corporate network operations, tracking personnel, controlling payroll and any other number of administrative services associated with the operation of a corporation or a business.

Other types of software components are also included within the IT systems 100 that can affect financial statements that are generated within the business environment. These can include things such as customer operations 106, wherein interfaces and interactions with the customer oftentimes use various types of financial reports and billing reports that are used with respect to customer interactions. Downstream systems 108 can include many types of downstream operations that are involved in the generation of financial system components and reports. These downstream systems can include anything that has some relationship to the generation of financial and customer operations within the overall IT network. Executive and external reporting 110 involve the generation of reports that are utilized by the executive management team for the corporation or business or reports that are provided externally to vendors, customers, etc. By their very nature, these types of reports will include financial information that can be affected by system upgrades which may occur in the IT system 102. While a number of components associated with the operation of the corporation or business IT system 102 are illustrated with respect to FIG. 1A, it should be realized that any number of additional components may be available within the IT system that may have some effect upon the financial status or statements that are produced within the IT system 102.

Each of the illustrated components described with respect to FIG. 1A are all interrelated with respect to the financial and customer operations of a business or corporate IT environment. When software components within the overall IT environment are upgraded, enhanced or changed in some fashion, there is a need to be able to confirm that each of the above system components with respect to the financial operations of the business or corporation have not been adversely affected. Financial components 104 require information that relates to each of the other components described within the IT system 102. The same can be said of each of the other components with respect to each of the other system components. Thus, when a certain portion of the system, for example the customer operations components 106 are updated via a software update, in addition to ensuring that the update does not create problems with respect to the functional operation of the customer operations components 106, it would be desirable to confirm the operation of the other system components, and in particular to determine the affects on the operation of the financial components 104 within the system in order to ensure that update of the customer operations components or other components has not adversely affected the operation of the financial components 104 within the overall IT system 102. In view of this, there is a need to provide the ability to provide some sort of financial system integration testing that can provide a mechanism to ensure the proper operation of financial transactions from end-to-end within a system with respect to the financial results generated by the system that may be effected by changes, upgrades or enhancements to network computer systems or software within an overall IT system 102.

Referring now to FIG. 1B, there is illustrated the flow of test data from a billing system 120 to the billing system reports 122. The billing system 102 provides information such as end of month data extracts 124 and information relating to billing business 126 that is provided to an associated revenue recognition module 130 and data warehouse 132, respectively. The revenue recognition module 130 utilizes the data extracts 126 to determine revenue that has been generated within the system. The data warehouse 132 utilizes the volume information to store tracking information that may be used for generating reports. The data warehouse 132 provides the information to an executive dashboard application 136 and enables the management and monitoring of such data stored within the data warehouse 132. Each of the revenue recognition module 130, data warehouse 132 and executive dashboard 134—are dependent upon accurate and timely information generated by the billing system data and reports 122. Thus, with respect to the analysis of financial processes within the illustrated billing system changes or updates to—the billing system, can affect the operation of the revenue recognition module, the detail data within the data warehouse or the executive dashboard and can potentially affect the information provided on the billing company's financial statements, internal and external reporting. Thus, some manner for tracking and reconciling this information would be of great benefit in the corporate or business environment in analyzing financial system operation.

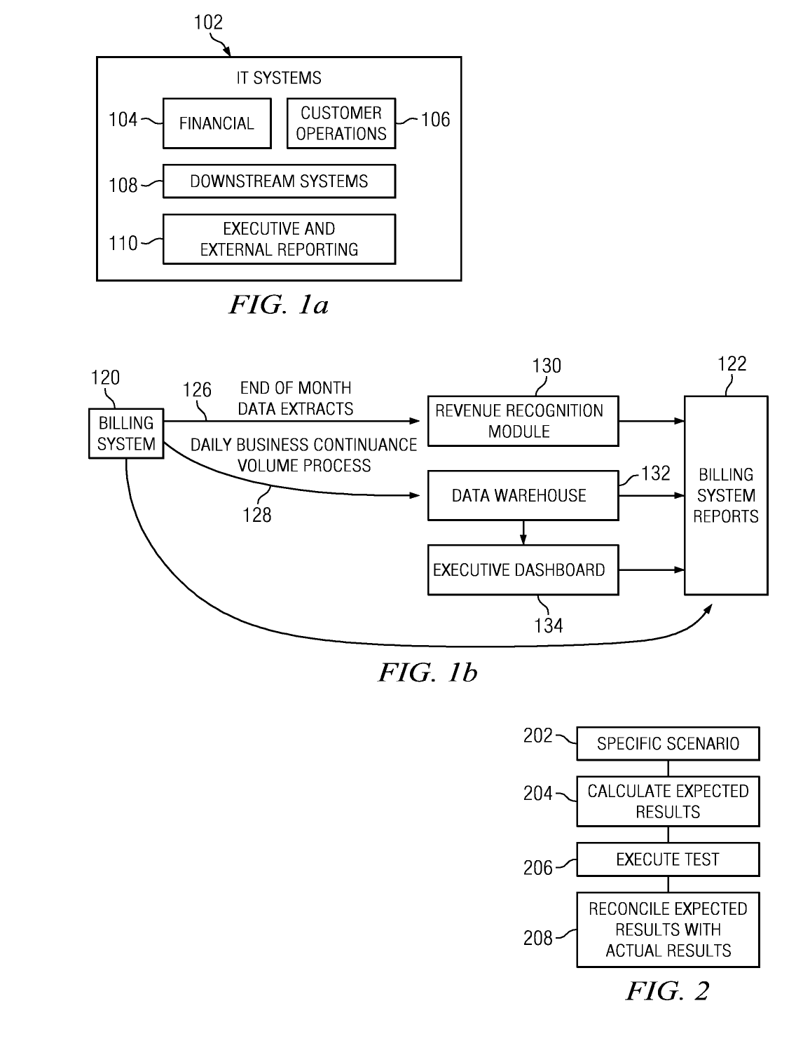

Referring now to FIG. 2, there is provided a general illustration of the way that a financial integration test may be used to provide end-to-end financial testing to ensure that the upgrading of other network hardware or software components will not adversely affect the operation of financial components within the overall IT system. FIG. 2 illustrates a flow diagram describing an overall end-to-end financial test process. Initially, at step 202, a number of detailed customer specific scenarios are devised with respect to particular financial system operations. These scenarios comprise, for example billing a particular customer for services used over a selected period of time or charging for use-based services. The designed scenarios will be specific to the business or corporation environment within which the financial system operation is being tested. The designed scenario can perform a number of functions for validating the testing of financial aspects of an upgraded system. The scenarios can define particular reference tables within the networks that are to be tested by the financial integration test. The scenario can test various operating environments within the corporate network to ensure that each environment is properly configured to perform the financial test associated therewith. Additionally, the scenarios can perform data identifications and selections to ensure that the data flowing through the system is being processed in the correct manner and is generated in a manner to be expected by the financial system components.

Based upon the specific scenarios that were designed, expected results arising from execution of the scenario responsive to particular inputs are calculated at step 204. These expected results are manually calculated or automatically calculated based upon a desired system operation so that it is ensured that the results achieved due to execution of the designated scenario are an accurate result that you would expect responsive to execution of the scenario.

Next, a test is executed on the upgraded system that generates results relating to the financial services that are being tested. This involves executing the upgraded systems involving the financial tests and providing particular financial focused inputs to receive particular financial focused outputs. The execution of the tests at step 206 generates actual results. The execution of the test to generate the actual results initially involves the synchronization of the external systems in which the various scenarios are going to be executed. This is to assure that the external systems are each beginning operations from a same point in time. Next, the data necessary to execute the scenarios are imported into the systems. The input data would be defined by the scenarios. The various types of reports including the test results such as accounting reports, database reports, etc., are then provided such that this information may be extracted and utilized within the comparison and reconciliation processes, which are more fully described hereinbelow.

The test results may then be reconciled with the expected results calculated at step 204 to determine disagreement between the expected and actual results at step 208. Inconsistencies between the provided actual results and the calculated expected results are used to correct system errors in order to ensure that the financial side components are executing in an accurate manner to properly reflect the financial situation of the corporation or business. The reconciliation process may occur at a number of levels within the financial components of the system, including the transaction level wherein actual financial transactions are being recorded and data created responsive to various financial transactions; at the database level wherein the information is being stored; at the report level wherein the ports utilizing generated financial data are compiled into financial reports for view by a user; and a tax verification level wherein various taxes and other types of government fees associated with financial transactions may be compiled and within external system report and data validation processes.

Using the above-described transactional level financial testing process rather than a merely a high level financial or functional testing process that monitors and tests the operations of the upgraded system components without particular focus or reference to the financial information being provided, provides a number of advantages. Using a functional testing process certain financial requirements that are required in view of the updated/changed/upgraded functionalities may be missed in the implementation due to the new requirements raised by the system upgrade. Functional testing focuses only on data issues and code issues that may not cover arising financial system inaccuracies that would arise even in a properly functioning system. Additionally, there is not a confirmation that all markets included under a financial analysis would be covered by mere functional testing.

Financially focused integration testing is able to consider all of the missing business requirements associated with each business area in an application. Since a user develops specific scenarios and looks for specific expected results as described in FIG. 2, confirmation that the desired information is achieved is enabled using this type of financially focused testing process. This can assist in filling in various business knowledge gaps within the upgraded system by determining financial-related information or data that is not presently covered by the system upgrade. Financial analysis testing of this type can provide for early detection of discrepancies that may occur between the business and financial operational aspects of the system. This type of analysis will involve all of the various components within the corporate environment enabling more focused tracking of revenue generation goals.

The implementation of a transaction level financially focused testing process can provide a number of benefits within a corporate or business environment. Various reference tables that are created within the financial environment can be verified end-to-end. Any necessary correction to charges, price plans, fees, reason codes, line ranges, etc., may be determined early on and implemented within response to upgrades or changes in the system. Tax tables associated with the financial operation of the corporation or business may also be corrected to properly reflect the market and governmental regulations. The generation of reports within the upgraded system as providing correct and accurate information may be verified. Online activities involving the financial operation of a corporate or business environment may be confirmed to have proper data flow within the upgraded systems such that all financially impacted flows and the functionalities are correctly configured. Additionally, user interfaces within the system may be confirmed to be operational within the upgraded systems such as payment interfaces, third party vendor interfaces, etc. Additional downstream applications that are affected by changes within the financial system can be verified to be operating in the correct manner along with the verification of various system maps.

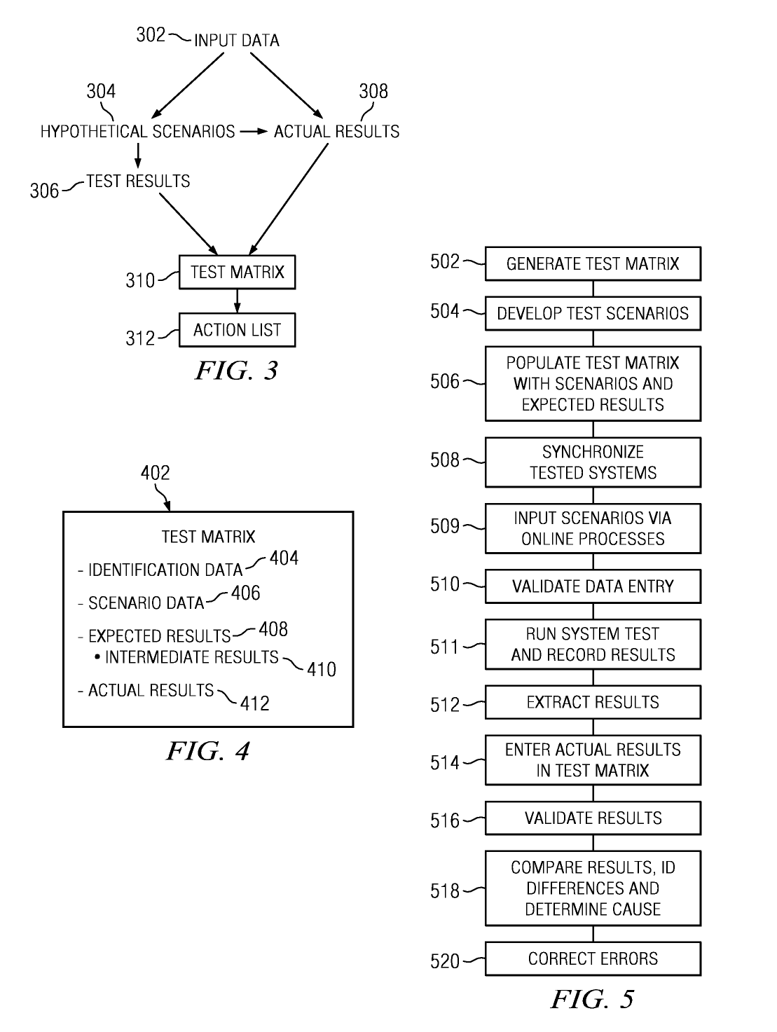

Referring now to FIG. 3, there is illustrated the manner in which a test matrix may be utilized in order to provide end-to-end financial testing of the financial components of a system. The input data 302 is provided to both the hypothetical scenario that have been developed to test the operation of the financial components of the system and to the actual updated system. The hypothetical scenarios 304 are used to generate expected test results 306. Thus, this provides the expected information that would be obtained from the upgraded system responsive to the hypothetical scenarios 304 that have been developed by a system tester. The input data 302 when provided to the actually updated system hardware and software provides actual results 308. Each of the determined expected test results 306 and actual test results 308 are stored within a test matrix 310. The test matrix 310 comprises a spreadsheet, database or other type of data maintaining or tracking structure that enables a comparison of the expected and actual test results in a logical fashion.

The test matrix 310 additionally includes the hypothetical scenarios 304 that are used to generate the expected test results 306. By associating each of the expected test results 306 with the actual test results 308, the test matrix 310 may be used to generate an action list 312 that is necessary for reconciling the differences between the expected test results 306 and the actual test results 308. This action list 312 provides system operators means for going back through the upgraded systems to determine the errors or problems that are causing the financial system to not accurately register the expected test results 306 that are desired to be achieved. In this manner, a test may be done solely based upon system financial requirements rather than just aggregating the system financial test results along with a number of other type of system results. This allows a financial side focus on the operations of the system to ensure that everything is operating in the correct manner.

Referring now to FIG. 4, there is provided a general illustration of the test matrix 402, which is used within the described method for storing information relating to the financial system integration test that is being performed. The test matrix 402 stores a number of different types of information that is utilized to determine problems or errors with respect to the operation of financial components of a network. Information that may be included within the test matrix 402 can include things such as identification data 404. The identification data 404 identifies particular individuals on which financial tests are being performed, certain business units on which the financial tests are being performed or any type of information identifying an account, individual, business entity, etc., on which the developed financial tests are being performed.

Scenario data 406 comprises the particular operation that has been designed to test the operation of the financial system components in a selected manner. The scenario data 406 may, for example include the generation of invoices with respect to particular customers in the system or generating accrued costs with respect to a particular business based upon monthly use-based fees or use fees or any other similar type of operation that may be carried out by the business or corporation. The scenario is designed to describe a particular financial operation that is associated in some way with the system under test.

The expected results data 408 comprises the information that is manually or automatically generated that provides the test results that should be achieved responsive to particular input data being provided to the scenario described by the generated scenario data 406. The expected results comprise the results that should be achieved if the newly upgraded system is operating in the expected manner with respect to its financial components. As part of the expected results 408, various intermediate results 410 may be included. This information can comprise tables, databases or additional results that are generated intermediate to the generation of the final expected results 408. This type of intermediate result information 410 may be used for determining the particular point at which errors within the operation of the financial system have occurred. Thus, if the actual results 412 are not consistent with the expected results 408, a user may work backward to the point at which the actual results no longer started meeting the expected results within the various determined intermediate results that are generated. At the first error detected within the intermediate results 410, the user may be relatively confident that the errors or problems existing within the execution of the financial system components are occurring within that area.

Finally, the actual results 412 reflect the actual results that are achieved when particular inputs are provided to the financial system and outputs are generated within the newly upgraded systems. The actual results 412 are compared with the expected results 408 in order to determine whether the financial system is operating in an expected manner.

The test matrix 402 may be specifically configured to include particular types of information/scenarios or identification information based upon the particular type of industry in which the financial integration test is being performed. The general types of information illustrated with respect to FIG. 4 broadly define the types of data that may be utilized within the test matrix 402. However, the particular types of information that are stored will each be uniquely designed and configured depending upon the type of business entity that is performing the test.

Referring now to FIG. 5, there is provided a flow diagram describing the operation of a financial integration system test using a test matrix 402 such as that described with respect to FIG. 4. Initially, at step 502, the test matrix 402 is designed and generated with respect to the financial system and type of business entity that is being tested. The testing matrix 402 can be configured for operation by including information, such as beginning balances, updating old dates within the test matrix and clearing old data within the test matrix. Additional columns and information can be added to the test matrix based upon newly determined requirements for performing the financial integration tests. Next, various test scenarios are developed at step 504. These tests scenarios are specifically related to the business that is performing the financial integration test and include transactions using the systems which have been changed/enhanced or upgraded. Each scenario must be documented such that it may be stored within the developed test matrix. An entire range of financial transactions may be encompassed by the developed test scenario that may include, but is not limited to, charges, payments, adjustments, transfers and units of service, etc. The generated test scenarios are used to populate the test matrix at step 506 with the expected results. Population of the test matrix involves storing the scenarios within the test matrix as well as generating and storing the expected results that are to be achieved from the execution of the designed testing scenario.

Next, the changed/enhanced/upgraded systems are synchronized at step 508. This is to ensure that all of the systems being tested initiate operations at a same beginning point. The system tests are input via online processes at step 509 and the input transaction data is validated via the database at step 510 before the tests are executed at step 511 responsive to the provided input data and established scenarios and the results that are generated from the actual execution of the changed/enhanced/upgraded systems are extracted at step 512 from the result reports, tables, ect. The extracted results can include the final results achieved from execution of the designed scenario as well as various intermediate results that are generated along the way.

The extracted actual results are entered into the test matrix at step 514 from the reports, tables, etc., that have actually been generated. These results either act to confirm the proper operation of the upgraded system or point to particular areas in which corrections or additional updates are needed in order to ensure that the expected results are correlated with the actual results that are achieved. These stored results are validated at step 516 in order to confirm whether the actual and expected results are consistent. Validation of the results ensures that the proper results have been accurately generated by the upgraded systems. The actual results and expected results are compared at step 518 to identify differences and determine causes for the discrepancies between the expected and exact results. These identified differences are used to correct errors within the system at step 520. Thus, by reconciling the test matrix results such that all expected results and actual results are equivalent, there are provided insurances of the integrity of financial transactions within upgraded systems. Thus, a mechanism is provided for insuring financial transactions are accurately reported when various changes/upgrades or enhancements have been made to associated computer systems within a business network environment.

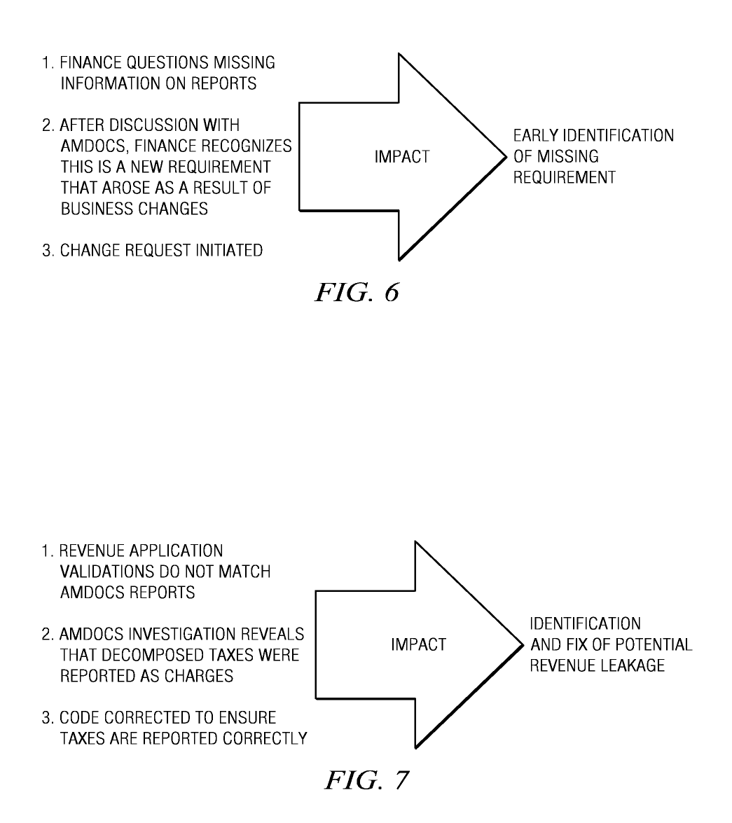

Referring now to FIGS. 6-9, there are illustrated various manners in which a financial integration test process such as that described with respect to FIG. 5 may be used to improve/affect the operation of a corporate or business operational environment. FIG. 6 illustrates a first set of problems detected wherein it is determined from the test matrix that particular financial questions are missing information from the output financial reports. After discussions with the billing system provider, a determination can be made that due to the upgrade of the system, there is a new requirement that has resulted from the system changes. A change may then be requested to implement this missing requirement within the system software resulting in the early identification and correction of the missing requirement.

Referring now to FIG. 7, there is illustrated a situation wherein the test matrix enables a determination that the expected revenue generation application and the actual revenue generation results do not match within the billing reports. An investigation reveals that certain decomposed taxes were reported as charges rather than as revenue. Codes must be then corrected within the billing system in order to ensure that taxes are recorded correctly. In this example, there is provided an early identification and fix of the potential revenue leakage problem within the business environment.

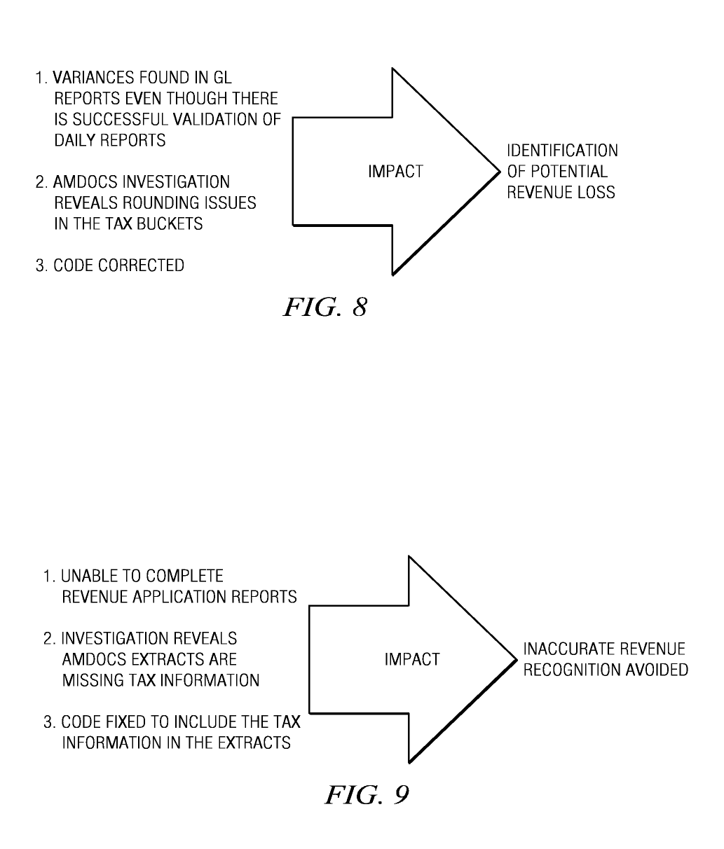

FIG. 8 illustrates a situation wherein there have been variances found in the General Ledger Financial reports even though there is a successful validation of the daily reports. An investigation reveals that there are rounding issues within the tax buckets of the system. A code correction may used to correct this problem again providing any identification and correction of a potential revenue loss.

Finally, as illustrated in FIG. 9, a situation is detected wherein a revenue application report is not able to be completed by the test matrix. An investigation reveals that the reports are unable to be completed due to missing tax information. A code fix is implemented in order to include the required tax information allowing the proper completion of the reports. This leads to the avoidance of inaccurate revenue recognition within the system.

Thus, as can be seen in the foregoing examples, analysis of the system using the test matrix and appropriately designed test scenarios leads to the correction of numerous system financial errors that would not be uncovered merely by a functional system test analysis. By focusing upon a financial integration test process, financially specific problems may be uncovered and corrected within the system in an efficient manner.

It will be appreciated by those skilled in the art having the benefit of this disclosure that this financial integration test process provides a process for providing end-to-end financial operations testing in an upgraded or changed system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for testing financial operations relating to network applications within a computer network, comprising the steps of:
generating a test matrix for storing test data relating to testing of financial operations related to the network applications within the computer network;
developing a unique testing scenario for testing the financial operations across a plurality of network applications;
storing the unique testing scenario within the test matrix;
calculating an expected financial result achieved in accordance with execution of the unique testing scenario;
storing the expected financial test result within the test matrix;
executing the unique testing scenario using the network applications within the computer network to achieve an actual financial test result;
storing the actual financial result within the test matrix; and
comparing the expected financial result with the actual financial result to detect issues within the network applications relating to financial operations.

2. The method of claim 1, wherein the step of calculating further comprises the steps of:
calculating at least one final expected financial result achieved in accordance with execution of the unique testing scenario; and
calculating at least one intermediate financial result achieve in accordance with execution of the unique testing scenario.

3. The method of claim 1, wherein the step of executing further comprises the step of synchronizing each system used in accordance with execution of the unique testing scenario.

4. The method of claim 1, wherein the step of storing the actual final result further comprises the step of extracting the actual final results from reports generated responsive to the execution of the unique test scenario.

5. The method of claim 1 further including the step of correcting errors detected responsive to the step of comparing with respect to financial operations executed using the network applications within the computer network.

6. The method of claim 1, wherein the step of comparing further comprises the steps of identifying differences between the expected financial results and the actual financial results to detect issues within the network applications relating to financial operations.

7. The method of claim 1 further comprises the step of storing the detected issues within the test matrix.

8. The method of claim 1 further comprising the steps of:
determining a cause of the financial issues detected responsive to the comparison; and
correcting the cause of the financial issues.

9. The method of claim 1, wherein at least one of the network applications or the computer network have been changed from a previous configuration.

10. A method for testing financial operations relating to network applications within a computer network, comprising the steps of:
generating a test matrix for storing test data relating to testing of financial operations related to the network applications within the computer network, wherein at least one of the network applications or the computer network have been changed from a previous configuration;
developing a unique testing scenario for testing the financial operations across a plurality of network applications;
storing the unique testing scenario within the test matrix;
calculating an expected financial result achieved in accordance with execution of the unique testing scenario;
storing the expected financial test result within the test matrix;
executing the unique testing scenario using the network applications within the computer network to achieve an actual financial test result;
storing the actual financial result within the test matrix;
comparing the expected financial result with the actual financial result to detect issues within the network applications relating to financial operations;
identifying differences between the expected financial results and the actual financial results to detect issues within the network applications relating to financial operations;
determining a cause of the differences responsive to the comparison; and
correcting the cause of the differences to remove the financial issues.

11. The method of claim 10, wherein the step of calculating further comprises the steps of:
calculating at least one final expected financial result achieved in accordance with execution of the unique testing scenario;
calculating at least one intermediate financial result achieve in accordance with execution of the unique testing scenario.

12. The method of claim 10, wherein the step of executing further comprises the step of synchronizing each system used in accordance with execution of the unique testing scenario.

13. The method of claim 10, wherein the step of storing the actual final result further comprises the step of extracting the actual final results from reports generated responsive to the execution of the unique test scenario.

14. The method of claim 10 further including the step of correcting errors detected responsive to the step of comparing with respect to financial operations executed using the network applications within the computer network.

15. The method of claim 10 further comprises the step of storing the detected issues within the test matrix.

16. A method for testing financial operations relating to network applications within a computer network, comprising the steps of:
generating a test matrix for storing test data relating to testing of financial operations related to the network applications within the computer network, wherein at least one of the network applications or the computer network have been changed from a previous configuration;
developing a unique testing scenario for testing the financial operations across a plurality of network applications;
storing the unique testing scenario within the test matrix;
calculating at least one final expected financial result achieved in accordance with execution of the unique testing scenario; and
calculating at least one intermediate financial result achieve in accordance with execution of the unique testing scenario;
storing the at least one final expected financial test result and the at least one intermediate expected result within the test matrix;
synchronizing each system used in accordance with execution of the unique testing scenario;
executing the unique testing scenario using the network applications within the computer network on the synchronized systems to achieve an actual financial test result;
storing the actual financial result within the test matrix; and
comparing the expected financial result with the actual financial result to detect issues within the network applications relating to financial operations.

17. The method of claim 16, wherein the step of storing the actual final result further comprises the step of extracting the actual final results from reports generated responsive to the execution of the unique test scenario.

18. The method of claim 16 further including the step of correcting errors detected responsive to the step of comparing with respect to financial operations executed using the network applications within the computer network.

19. The method of claim 16, wherein the step of comparing further comprises the steps of identifying differences between the expected financial results and the actual financial results to detect issues within the network applications relating to financial operations.

20. The method of claim 16 further comprising the steps of:
determining a cause of the financial issues detected responsive to the comparison; and
correcting the cause of the financial issues.
